(19) United States
(12) Patent Application Publication
(10) Pub. No.: US 2006/0015422 A1
(43) Pub. Date: Jan. 19, 2006

(54) Method for financing a loan

(76) Inventor: Paul E. Dion, Sarasota, FL (US)

Correspondence Address: MAYER, BROWN, ROWE & MAW LLP, 1909 K STREET, N.W., WASHINGTON, DC, 20006, US

(21) Appl. No.: 10/890,227

(22) Filed: Jul. 14, 2004

(51) Int. Cl. G06Q 40/00

(52) U.S. Cl. 705/35

(57) ABSTRACT

A method for financing a product or service that includes determining a first loan amount and calculating a first periodic payment and a first term based on the first loan amount. The method further includes determining a supplemental allowance for a borrower and calculating a revised loan amount by summing the first loan amount and the supplemental allowance. Once the revised loan amount is determined, a revised periodic payment and a revised loan term based on said revised loan amount are determined; and the revised loan term is reduced by applying a second periodic payment schedule based one of the first periodic payment and the revised periodic payment.

### FIELD OF THE INVENTION

The present invention relates to a method of financing. More specifically, the present invention relates to a method of financing a purchase of a product or service that provides a borrower with alternative and/or flexible repayment options.

### BACKGROUND OF THE INVENTION

Conventionally, consumers that purchase products or services choose to finance the purchase since it allows the consumer to afford the product or service that would otherwise be unaffordable. Traditionally, the financing that a borrower receives comes from a lender and the agreement between the lender and the borrower obligates that borrower to repay the fixed loan amount over a fixed period of time at a fixed interest rate. Generally, the time for repayment is between 1 and 30 years depending on the product or service. For example, home mortgages generally have 15 or 30 year terms, where certain services such as consulting fees may have shorter terms (e.g., 1 to 2 years). Additionally, the repayment schedule for the above described loans generally requires that the borrower repay the loan with equal monthly payments which are due on the same day each month. Accordingly, a borrower for a mortgage may make 360 equal payments for 30 years and such payments would be due on, for example, the tenth day of each month. Generally, each of these payments included an interest portion and a principal payment.

One variation on this type of lending is the adjustable rate mortgage (“ARM”). This type of a loan, generally reserved for home purchases, allows the rate to fluctuate based on financial market fluctuations and generally includes a lower initial interest rate that increases over time. Accordingly, the borrowers monthly payment described above will fluctuate, sometimes on a monthly basis. Unfortunately, ARMs may adversely affect the borrower since the interest rate can increase to a level where the borrower cannot afford to make the monthly payment. Over time, borrowers began to realize that ARMs may not be their best option and tended to obtain a “conventional” type of loan described above. Additionally, ARM loans have traditionally only been available for homes and therefore did not allow borrowers of other products or services to benefit from such a program.

In another variation, lenders have allowed borrowers to finance products and services for longer periods of time. For example, automobile loan terms have recently increased from a five year maximum term to a seven or eight year maximum term. This adjustment in loan term has allowed borrowers to borrow more since their monthly payments can be less for the longer term. However, this type of adjustment on the loan also generally caused an increase in the interest rate which combined with the longer term, requires a borrower to pay more money to the lender over time even though each payment may be less. Further, since, in this example of an automobile, the value of the product is decreasing, it is more likely that the rate of depreciation may exceed the rate of repayment and the borrower will owe more than the automobile is worth.

More recently, lenders have allowed borrowers to repay loans on a biweekly basis. Although this type of a repayment has been reserved for home purchases, some services, such as SmartNote and GMAC Financial Services, have allowed borrowers to use the biweekly payment for automobiles, recreational vehicles, and boats. The biweekly repayment program allows a borrower to make payments equal to one-half of their monthly payment on a biweekly basis.

As shown in FIG. 1A and FIG. 1B, if the loan is paid biweekly, the borrower generally pays an amount equal to the monthly payment per month. However, as shown in, for example FIG. 1A, during two of the months, the borrower makes an extra payment equal to one half of their monthly payment. In the Example shown in FIG. 1A, the months of April and October include the extra biweekly payment. In effect, the biweekly payment option results in thirteen monthly payments (26 biweekly payments) being made per year instead of only twelve monthly payments. These extra biweekly payments, allow the borrower to pay the loan sooner than with the conventional monthly payments described above.

FIG. 2 and FIG. 3 are an amortization table and chart, respectively, that more easily illustrates how the biweekly payment allows a borrower to pay the loan sooner. The example illustrated in FIGS. 2 and 3 are for a loan of $200,000 at 6% interest for 25 years. As seen in FIG. 2, the same loan with the same terms is paid in full at the end of 21 years instead of at the end of 25 years with a monthly payment. FIG. 3 shows a chart with the same data where the circles indicate the biweekly payments and the triangles indicate the monthly payments. As can be readily seen from the chart in FIG. 3, the additional amount of equity can grow significantly over time.

Although the biweekly payments give borrowers of these specific products a better solution for repaying their loans, these programs are still quite rigid. For example, a growing number of borrowers for automobile purchases are also purchasing aftermarket products for their vehicles. Examples of such products may include upgraded audio/video equipment, upgraded performance items, upgraded appearance items and upgraded safety and security items. These types of products are often desired by the borrower and can sometimes be financed with the purchase of the automobile. However, often times the borrower cannot afford the additional monthly cost of the product, even with the biweekly payments or the lender may not allow the borrower to borrow the additional amounts required. This can have direct adverse effects on the borrower. For example, without the appropriate safety features, the borrower will not be as safe as he/she could be and in addition, the borrower may not qualify for insurance discounts and might have to pay more for such insurance. Accordingly, the borrower is not able to purchase the desired aftermarket products and the retailer is not able to sell the products. Alternatively, the borrower might increase the repayment term to make the products affordable both from the borrower's perspective and from the lender's perspective. But as discussed above, it is generally detrimental to the borrower, although very profitable for the lender, for the borrower to increase the repayment term.

Accordingly, a need exists to provide alternative and/or flexible financing options to borrowers that purchase products or services.

### BRIEF SUMMARY OF THE INVENTION

An object of the present invention is to provide additional financing options to borrowers by allowing the borrower to take advantage of novel combinations of financing options.

Another object of the present invention is to make borrowing money more affordable for the borrower.

Yet another object of the present invention is to incorporate a biweekly payment option with the additional cost of added products or services without substantially increasing the borrower's monthly payment amounts.

Yet another object of the present invention is to incorporate a biweekly payment option with the additional cost of added products or services without substantially increasing or decreasing the borrower's repayment term.

Yet another object of the present invention is to incorporate a biweekly payment option to allow a borrower to build equity in a product faster than with conventional loans.

Yet another object of the present invention is to allow borrowers to more quickly repay loans so they can purchase additional products sooner.

### BRIEF DESCRIPTION OF THE DRAWINGS

Additional objects, features, and advantages of the present invention will become apparent from the following detailed description of the preferred embodiments of the invention in conjunction with the accompanying drawings, in which:

FIGS. 1A and 1B are 2004 calendars illustrating a payment schedule in accordance with a biweekly repayment schedule;

FIG. 2 is a table illustrating how the biweekly payment schedule shortens the repayment term of a loan in comparison with a conventional monthly repayment schedule;

FIG. 3 is a graphical representation of the information provided in FIG. 2;

FIG. 4 is a block diagram of a method of financing a product or service in accordance with an embodiment of the present invention;

FIG. 5 is a block diagram of a method for determining a supplemental allowance in accordance with the embodiment of the present invention illustrated in FIG. 4;

FIG. 6 is a block diagram of a method for financing a product or service in accordance with another embodiment of the present invention;

FIG. 7 is a block diagram of a method for financing a vehicle in accordance with another embodiment of the present invention;

FIG. 8 is a block diagram of a method for financing a product or service in accordance with yet another embodiment of the present invention;

FIG. 9 is a graphical comparison of a loan in accordance with the embodiment of the present invention illustrated in FIG. 8 with a conventional loan;

FIG. 10 is block diagram of a method for financing a product or service in accordance with another embodiment of the present invention; and

FIG. 11 is a block diagram of a method for adjusting loan parameters in accordance with the embodiment of the present invention illustrated in FIG. 8.

### DETAILED DESCRIPTION OF A PREFERRED EMBODIMENT

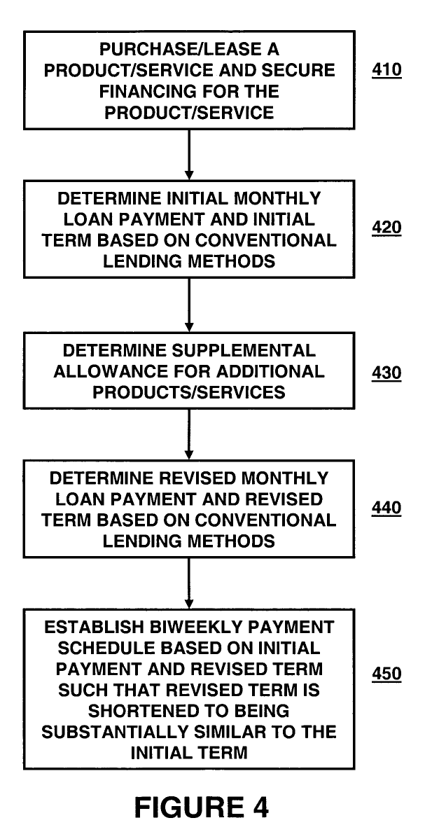

FIG. 4 is a block diagram of a method of financing a product or service in accordance with an embodiment of the present invention. In the embodiment shown in FIG. 4, the borrower purchases or leases a product or service and obtains financing for the purchase of the product or service in step 410. In general, it does not matter whether the borrower purchases the product or service first or whether the borrower obtains financing first. Once the borrower has made a purchase and obtained financing, however, the borrower may use the biweekly supplemental allowance program of the present invention described herein. Accordingly, the next step 420 is to determine an initial monthly loan payment and an initial loan term for the financing and by dividing the initial monthly loan payment in half, the initial biweekly loan payment can be determined as well. These determinations can be made by any conventional means including software tools that make these calculations easier. Once the borrower has an acceptable initial loan term and initial biweekly loan payment, the next step 430 is to determine a supplemental allowance to allow the borrower to obtain additional products or services. After the borrower has a supplemental allowance for additional products or services, a revised monthly loan payment and revised loan term are determined, as shown in step 440, based on the initial loan amount plus the supplemental allowance. Again, as discussed above, the determination of these revised parameters can be obtained with conventional methods, including for example, conventional (prime) lending, subprime lending, etc.

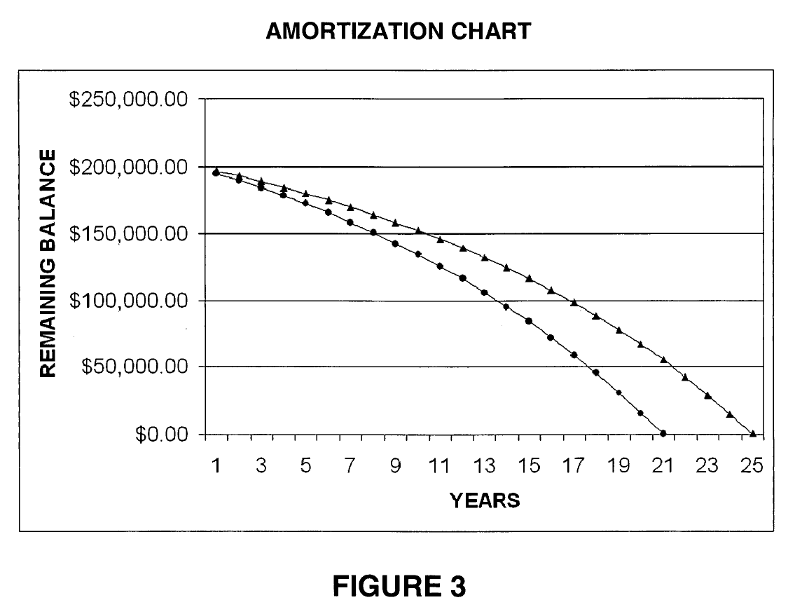

Lastly, after obtaining the revised loan term and the revised monthly loan payment, a biweekly payment schedule is established based on the initial biweekly loan payment in step 450 such that the revised loan term is shortened to be substantially equal to the initial loan term. As discussed above with respect to FIG. 3, by applying a biweekly payment schedule, the effective length of the loan term can be reduced. Accordingly, by increasing the initial loan term to obtain a revised loan term and then applying the biweekly payment schedule to the revised loan term, the revised loan term can be reduced to an effective term that is substantially similar to the initial loan term. Although FIG. 4 describes the borrower's payment as being based on the initial biweekly loan payment, it should be readily understood that a biweekly loan payment based on the revised loan amount would also be acceptable. Furthermore, in this example, and as described below, the revised loan payment and the initial loan payment are substantially similar.

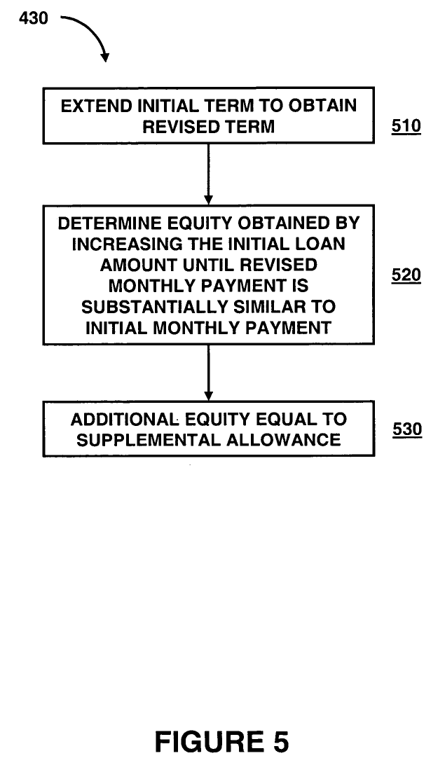

FIG. 5 is a block diagram of a method for determining a supplemental allowance in accordance with the embodiment of the present invention illustrated in step 430 of FIG. 4. As illustrated in FIG. 5, step 510, the initial loan term is extended to obtain a revised loan term. Once the revised loan term is obtained, equity is added to the initial loan amount until the revised monthly payment is substantially similar to the initial monthly loan payment, in step 520. The additional equity, as illustrated in step 530, is equal to the supplemental allowance.

Accordingly, for example, if a borrower obtains an initial loan for $32,700 for a 60 month initial loan term, the initial monthly loan payment would be about $600 (assuming a 4% interest rate). The initial loan term could be increased to a revised loan term of 66 months and equity could be added to the initial loan amount until the revised monthly loan payment was substantially similar to the initial monthly loan payment. In this example, the revised loan amount would be about $34,800. Accordingly, the supplemental allowance for the borrower would be about $2,100. This supplemental allowance could be used by the borrower to purchase additional products or services or, in some embodiments, may simply be disbursed to the borrower as cash and/or may be applied to offset any negative equity a borrower may have. Finally, as illustrated in step 450, a biweekly payment schedule could be established to reduce the revised loan term to 60 months, or substantially the same as the initial loan term by using a biweekly payment based on the revised or the initial monthly loan payment.

Often, especially for shorter loan terms, the increase in months of the revised loan term may be approximately equal to the length of the initial loan term in years. Accordingly, in the above example, the initial loan term of 60 months is 5 years, so adding about 5 months to the initial loan term to obtain a revised loan term (e.g., 65 or 66 months), ensures that the biweekly payment schedule will reduce the revised loan term back to the initial loan term. As the loan terms increase, for example to 30 years, this generalization may not be as accurate.

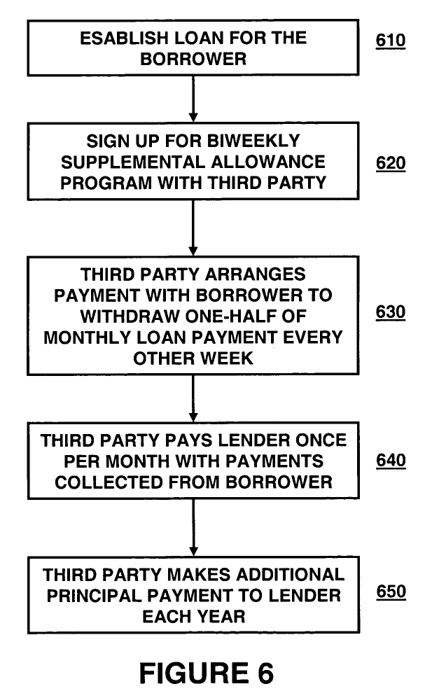

In certain situations sellers of products or services do not accommodate financing and lenders are often not willing to accept biweekly payments for a loan. Accordingly, FIG. 6 is a block diagram of a method for financing a product or service in accordance with another embodiment of the present invention. The method illustrated in FIG. 6 is especially useful when lenders or sellers are not willing to implement the method described above with respect to FIGS. 4 and 5. In step 610 the borrower establishes a loan with a lender. The borrower is then exposed to the biweekly supplemental allowance program as explained in the above embodiment. If the borrower decides to enroll in the biweekly supplemental allowance program, the loan is modified accordingly (to allow for a supplemental allowance) and the borrower enrolls in the program at step 620 with a third party company. Often the seller or lender may assist in this process or may leave it to the borrower to complete the registration for the biweekly payment schedule with the third party. Additionally, the seller or lender may act as the third party in some situations.

Once the borrower has enrolled in the biweekly program, the third party, in step 630, arranges payment with the borrower such that the third party receives one-half of the borrower's monthly payment (either the initial or revised payment, as described above) every other week. Although, it is generally preferred that the borrower authorize a direct withdrawal from the borrower's account, any conventional method of sending money to the third party is acceptable (e.g., paper check, wire transfer, or hand delivery to name a few). As these payments are collected by the third party, which as discussed above could also be the seller or lender, the third party pays the lender once per month as shown in step 640.

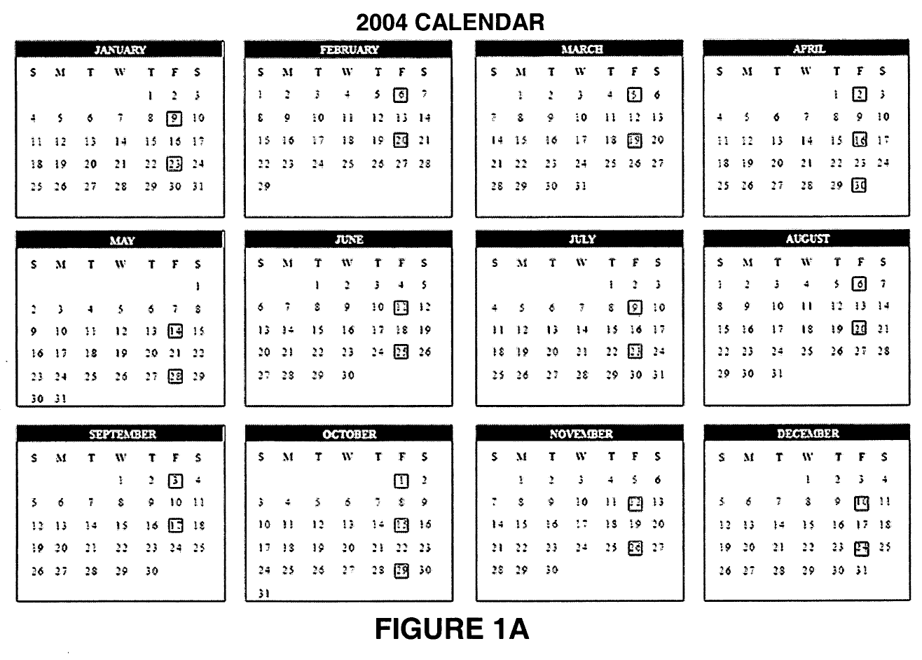

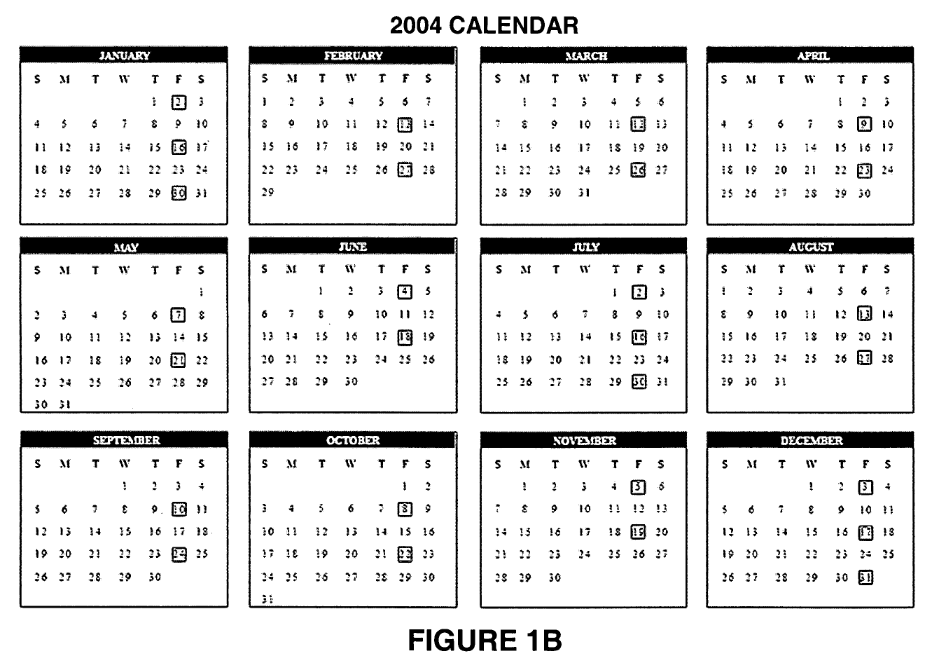

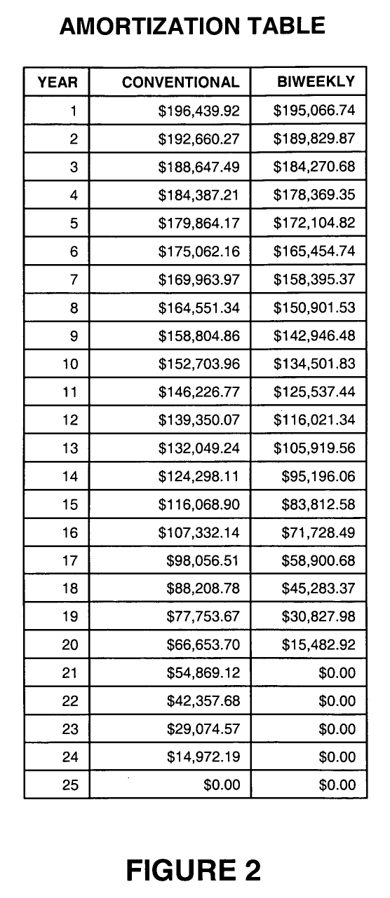

However, referring to FIGS. 1A and 1B, the third party will collect more money in a year than it will send to the lender if the third party only pays the lender the monthly loan payment every month. For example, on the calendar in FIG. 1A, the third party collects extra money in April and October. Accordingly, with the extra payments made by the borrower (effectively an additional monthly payment in this example), the third party, as shown in step 650, can make an additional principal payment at least once per year. As would be understood by a person skilled in the art, the additional principal payment may be offset by any fees the third party may collect. Preferably, the principal only payments are made twice a year from the payments collected during the months that an additional biweekly payment is collected (e.g., April and October, as shown in FIG. 1A).

Additionally, although the above example assumes that a lender will not accept payments biweekly, it is possible that some lenders may accept such a biweekly payment. In this case, as would be understood by a person skilled in the art, the most beneficial payment schedule for the borrower would have the lender paid biweekly.

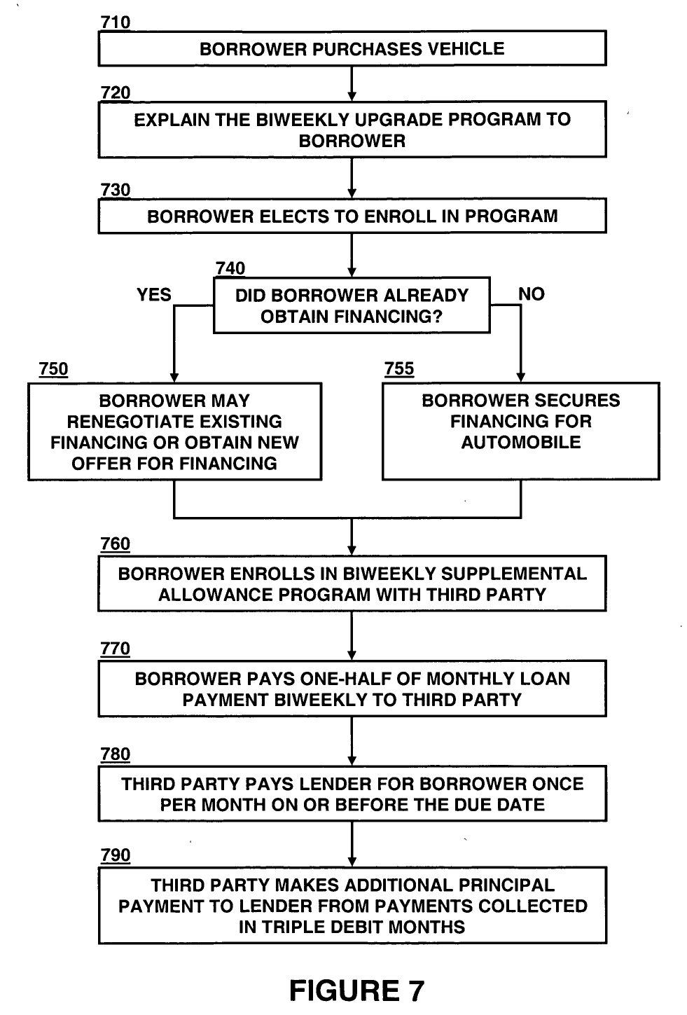

One type of product that can be financed using the method of the present invention is an automobile. Accordingly, FIG. 7 is a block diagram of a method for financing a vehicle in accordance with another embodiment of the present invention. As shown in FIG. 7, step 710, the borrower purchases, leases, or selects for purchase or lease a vehicle. Assuming that the borrower will finance the purchase, in the next step, step 720, the biweekly supplemental allowance program is explained to the borrower. If the borrower is interested in the biweekly supplemental allowance program and enrolls in the program at step 730, the next step 740 is to determine whether the borrower has already obtained financing. If the borrower has already obtained financing, the borrower may need to renegotiate the financing terms, as illustrated in step 750 with the borrower's lender or may need to cancel the financing and obtain new financing. Whether the borrower cancels the original financing or does not have financing, the borrower will be required to secure financing in step 755. Often the vehicle seller may assist the borrower with this process (for example, if the seller were a dealer) or the borrower can obtain the required financing from a different lender.

Generally, the loan amount that the borrower receives will be for the purchase price of the vehicle (plus any required fees) and the cost of the upgrades selected less any amount that the borrower pays initially. Some of the more common upgrades that borrowers may add to their vehicle purchase include performance equipment, upgraded audio/video equipment, upgraded appearance items, upgraded safety and security items, extended warranty service contracts, reduction of any negative equity that might be present in a previous vehicle, a cash disbursement, etc. Additionally, the loan term that the borrower generally obtains is the revised loan term as discussed above. Accordingly, the loan parameters, using the example discussed earlier, would result in the borrower obtaining financing for $34,800 for a term of 66 months. This satisfies a lender that, as discussed above, may not be willing to accept biweekly payments.

Once the borrower has secured financing by any appropriate means, the borrower enrolls in the biweekly supplemental allowance program in step 760. The structure of the biweekly supplemental allowance program was described above with respect to FIGS. 4-6 so such a detailed discussion is omitted in this discussion. After the borrower is enrolled in the biweekly supplemental allowance program, the borrower begins paying the third party the owed loan payments, step 770. The borrower no longer pays the lender. In this embodiment, the borrower pays the third party half of the monthly loan payment biweekly. Once the third party collects the payments from the borrower, the third party pays the lender the revised monthly loan payment on behalf of the borrower as illustrated in step 780.

Additionally, the third party makes an additional principal payment on the loan on the borrowers behalf from the extra payments that are collected from the borrower in step 790. As can be readily seen from FIGS. 1A and 1B, these extra payments may occur twice or three times per year. Accordingly, the effective number of biweekly payments per month for the borrower is 2.17 assuming, of course, that the borrower does not make any additional payments to the lender directly or the third party.

Additionally, as discussed above, the lender, if willing to accept payments biweekly, could also be paid biweekly. Further, it is not necessary that the lender, seller and third party be distinct persons. For example, the lender or seller could perform the duties of the third party company.

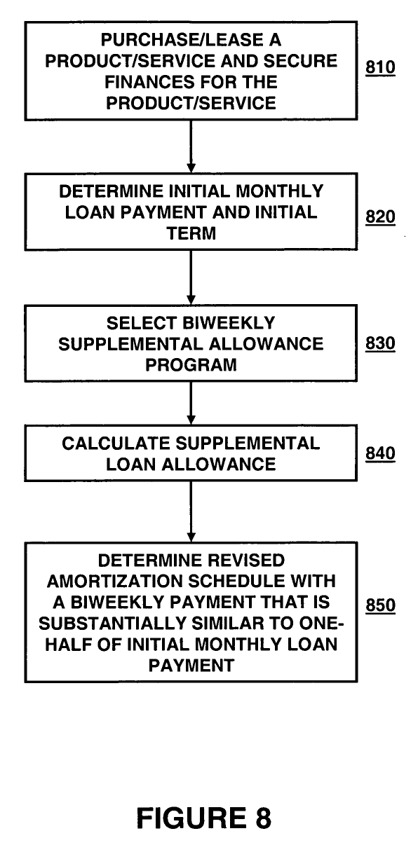

FIG. 8 is a block diagram of a method for financing a product or service in accordance with yet another embodiment of the present invention. As with the previous Figures, the first step 810, is for the borrower to purchase or lease a product or service. Next, an initial loan term and initial monthly loan payment are determined in step 820. If the borrower elects the biweekly supplemental allowance program of the present invention, in step 830, the next step 840 is to calculate a supplemental loan allowance for the borrower to purchase or lease additional products or services. Based on this information, a revised client amortization schedule is determined in step 850 where the borrower's biweekly payment is substantially equal to one-half of the borrower's initial monthly loan payment. Further, even with the supplemental loan allowance, the borrower's loan term is substantially equal to the initial loan term. The amortization schedule, as described below, may also include any fees that a borrower may be charged for the service provided by the present invention.

As described above in previous embodiments, the method of the present invention can be applied to compounded interest loans or simple interest loans. EQUATION 1 illustrates a method for determining a periodic loan payment (A) in accordance with step 820 for a compounded interest loan.

$$A = \frac{{r ( 1 + r )}^{n} P}{{( 1 + r )}^{n} - 1} \qquad \text{Equation 1}$$

In Equation 1, P is the initial loan amount, n is the total number of periods in the loan term, and r is the interest rate for each period. Accordingly, for example, if a borrower wants a $100,000 loan for a loan term of 5 years with monthly payments and an annual interest rate of 10%,
P=$100,000
n=(12 months/year)(5 years)=60
r=10% per year/12 months per year=0.833%

By substituting these values into Equation 1 above, a monthly loan payment A is determined as $2124.70. Once the monthly loan payment is determined, a biweekly loan payment of $1062.35 is determined by dividing the initial monthly loan payment by 2. As described above, the next step 840 is to determine a supplemental loan allowance that the borrower can obtain. The supplemental allowance that is calculated should allow the borrower to pay approximately the above biweekly loan payment of $1062.35 for the approximate duration of the initial loan term (i.e., 5 years).

With just the biweekly payments, of which there are about 26 per year and therefore, about 130 in the 5 year term, EQUATION 2 illustrates that the initial loan amount with the above terms can be paid in approximately 117 biweekly payments if no additional payments are made.

$$n = \frac{- ln ( 1 - \frac{rP}{A} )}{ln ( 1 + r )} \qquad Equation 2$$

Accordingly, to calculate the supplemental loan allowance, EQUATION 3 is used to determine the revised loan amount P′.

$${P}^{′} = \frac{A}{r} ( 1 - {( 1 + r )}^{- n} ) \qquad Equation 3$$

In Equation 3, A is the initial biweekly payment amount, r is the periodic interest rate with biweekly payments, and n is the number of payments per year times the number of years in the term (i.e., 130). Accordingly, in this example,
A=$1062.35
r=10% per year/26 periods per year=0.384%
n=(26 biweekly payment per year)*5 years

By substituting these values into Equation 3, P′=$108,484.08. Accordingly, the supplemental loan allowance that a borrower may obtain while maintaining the initial biweekly payment of $1062.35 and initial loan term of 5 years is $8,484.08.

Furthermore, the borrower may be required to pay a fee for this service. For example, the borrower may be required to pay $395 dollars to enroll in the program and an additional $3.95 service fee each time a biweekly payment is paid. Although these fees could be paid up front, they may also be incorporated into the loan payments without changing the initial biweekly payment. In this case, for example, the enrollment fee could be deducted in two equal installments from the first two extra biweekly payments (i.e., as discussed above with respect to FIGS. 1A and 1B, the months when a third biweekly payment is made). Of course, as would be understood by a person skilled in the art, if such an enrollment fee is collected, the fee could be divided into any number of payments and each payment does not need to be equal to any other payment.

If the borrower elects to have the biweekly service fee deducted from the biweekly payment (instead of adding the amount to the payment), the supplemental loan allowance will need to be reduced by a first deduction amount S₁ as shown in EQUATION 4, where f is the fee amount ($3.95), r is the periodic interest rate as calculated above with respect to Equation 3, and n is the total number of payments (130).

$${S}_{1} = \frac{f}{r} ( 1 - {( 1 + r )}^{- n} ) \qquad Equation 4$$

Accordingly, by substituting the correct values, S₁=$403.50.

Additionally, if the initial fee is deducted from the extra monthly payments, the supplemental loan allowance will also have to be reduced by a second deduction S₂ as shown in EQUATION 5.

$${S}_{2} = \frac{G}{2} ( {( \frac{1}{1 + r} )}^{a} + {( \frac{1}{1 + r} )}^{b} ) \qquad Equation 5$$

In Equation 5, G is the amount of the initial fee ($395), r is the same periodic interest rate discussed above, and a and b are the respective period in which the additional payments fall. For example, in this embodiment, the loan may begin on a certain date, and the extra biweekly payments may be collected during the 3^{rd} and 14^{th} periods (See FIG. 1B if loan is started on Jan. 1, 2004). In this case, S₂=$382.40.

In another embodiment, the fee may be collected sooner if, for example, the lender has a 45 day grace period before the initial monthly payment is due, the fee may be collected during the first and sixth period. Of course, as would be understood by a person skilled in the art, a number fee collection schedules may be established.

Therefore, with respect to the fees being collected during the 3^{rd} and 14^{th} periods, the total supplemental allowance in this situation would be $8,484.04−403.50−382.40=$7,698.14.

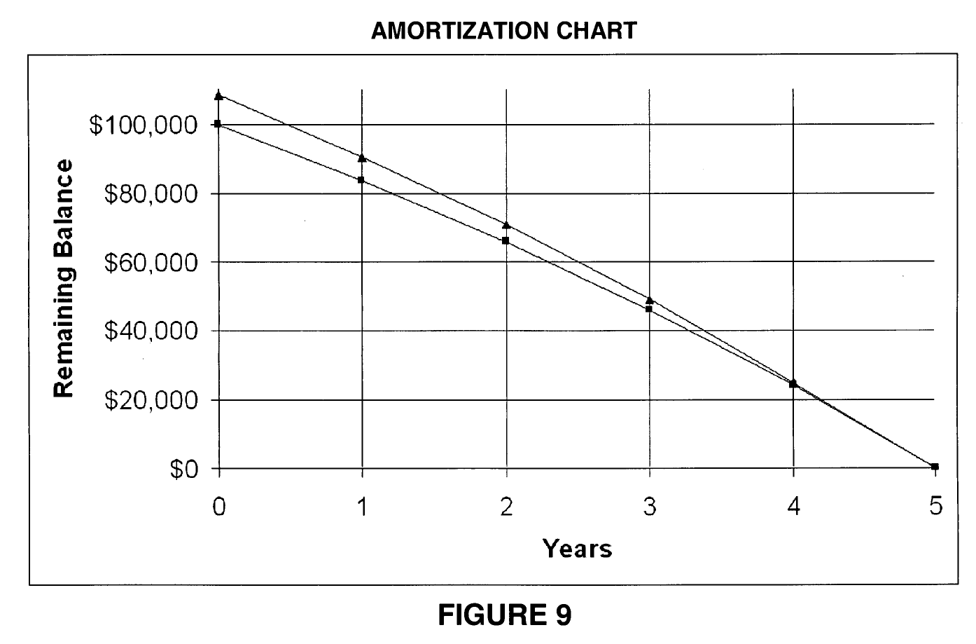

FIG. 9 is a comparison of a loan in accordance with the embodiment of the present invention illustrated in FIG. 8 with a conventional loan. As can be readily seen from this graph, the initial balance of the biweekly loan is $8,484.04 more than the $100,000 loan amount with the conventional loan. However, both loans are paid in the same amount of time.

Additionally, as would be understood by a person skilled in the art, this method of calculation is similar to the other methods described herein. Specifically, in practice, the borrower may actually be required to obtain a loan for P′ for a term that is longer than 5 years. For example, a loan term extension of 6 months (as described in the example provided with FIG. 4), to 66 months with the same parameters described above with respect to FIG. 8, results in a revised monthly loan payment that is substantially similar to the initial monthly loan payment. Accordingly, the 66 month loan, for the larger loan amount P′ could be paid in 60 months by making biweekly payments equal to the initial biweekly loan amount of 1062.35.

For a simple interest loan, similar principles apply. The equations however, change.

To calculate the simple interest monthly loan payment A, EQUATION 6 instead of Equation 1 would be used. Where i is the annual interest rate.

$$A = {\sum }_{k = 1}^{n} ( \frac{1}{1 + \frac{ki}{12}} ) \qquad Equation 6$$

To calculate P′, EQUATION 7, not Equation 3 would be utilized.

$${P}^{′} = A ( {\sum }_{k = 1}^{n} ( \frac{1}{1 + \frac{ki}{26}} ) ) \qquad Equation 7$$

S₁ and S₂ would be calculated with EQUATION 8 and EQUATION 9, respectively instead of Equations 4 and 5, respectively.

$$\begin{matrix}{S}_{1} = \frac{f}{1 + \frac{i}{26}} {\sum }_{k = 1}^{n} ( \frac{f}{1 + \frac{ki}{26}} ) & Equation 8 \\ {S}_{2} = \frac{\frac{G}{2}}{1 + \frac{ai}{26}} + \frac{\frac{G}{2}}{1 + \frac{bi}{26}} & Equation 9\end{matrix}$$

In Equations 6-9, n is the total number of payments.

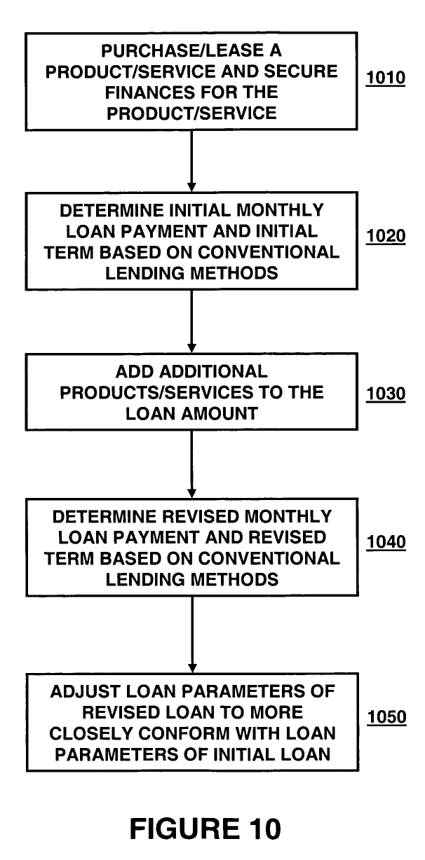

FIG. 10 is block diagram of a method for financing a product or service in accordance with another embodiment of the present invention. As illustrated in FIG. 8, the first step 1010, is for the borrower to purchase or lease a product and secure financing for that product. Once these steps are complete in either order, in step 1020, an initial loan term initial monthly payment are determined that are acceptable to the borrower. As discussed above the borrower may receive assistance from any of the lender, borrower or some other party in this determination.

After the borrower has the initial loan terms, the borrower may then select additional products or services that the borrower may want to couple with the purchase of the initial product or service, as shown in step 1030. After adding the additional amounts to the initial loan amount, the next step 1040, is to determine a revised monthly loan payment and loan term. After the borrower has the initial and revised terms, in step 1050, the loan parameters of the revised loan can be adjusted such that the parameters more closely conform with the initial loan parameters.

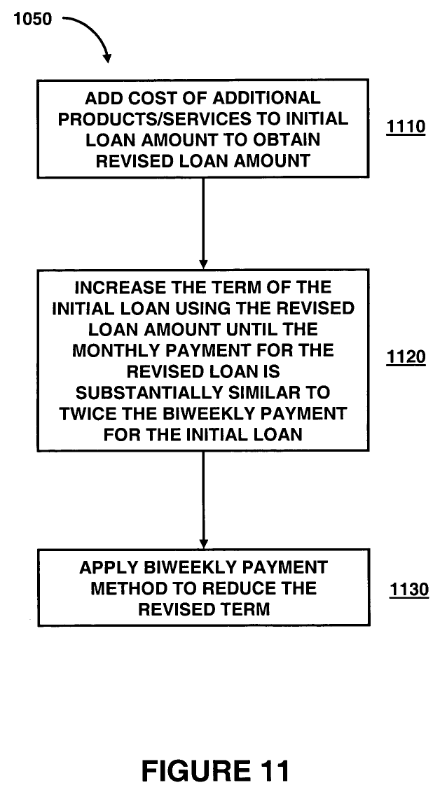

FIG. 11 is a block diagram of a method for adjusting loan parameters, illustrated in step 1050, in accordance with the embodiment of the present invention illustrated in FIG. 10. As shown in FIG. 11, the process of adjusting the loan parameters first includes adding the cost of the additional products or services to the initial loan amount to obtain a revised loan amount, as illustrated in step 1110. With the revised loan amount, the revised monthly loan payment is determined using the initial loan term and as shown in step 1120, the initial loan term is increased until the revised monthly loan payment more closely resembles the initial monthly loan payment that was determined for the borrower to obtain the revised loan term. Lastly, in step 1130, the biweekly payment schedule discussed above is applied to the revised loan term to reduce the revised loan term to more closely resemble the initial loan term.

Accordingly, for example, with the example used in previous embodiments, the borrower is not restricted to using only the $2,100 allowance. In this embodiment, the borrower could, for example, purchase an additional $3000 in additional products or services. In this case, the loan term may be extended to 67 months instead of 66 months and the borrower could use the biweekly payment schedule to reduce the loan term to, for example, 61 months. Alternatively, the borrower may decide that the 60 month term is more important to the borrower and have slightly higher monthly loan payments by taking the $3000 and only extending the loan term to 66 months. In this case, the loan will be paid in the original 60 months. As would be readily understood by a person skilled in the art, based on the above disclosure, other variations of this method are also possible. For example, the borrower could use less than the $2100 allowance or could use an additional amount to reduce or eliminate negative equity in an existing product or service.

As would be understood by a person skilled in the art, there may be several additional considerations involving the present invention. For example, electronically transferred borrower funds may have to be transferred through the Automated Clearing House in accordance with Federal Reserve regulations. Additionally, since payments are generally only made to the lender on a monthly basis, an escrow account may need to be established to hold the borrowers funds before they are paid to the lender. Further, as discussed above, to encourage sellers to participate in the program the seller may receive a fee for sending borrowers to the third party and the third party may also charge certain fees. In embodiments, these fees would be taken out of the initial extra biweekly payments and/or with subsequent payments. As would be readily understood by a person skilled in the art, the collection of a fee is not an essential element of the present invention. Such a service could be offered without such a fee.

Further, the above embodiments describe a general financing situation and a vehicle loan situation. It should be understood by a person skilled in the art that the principles of the present invention would apply to any product or service that may be purchased through financing. Examples of such products and services may include, automobiles (vans, trucks, SUVs, hybrids etc.), motorcycles (street and off road applications), water craft (boats, ships, yachts, dingies, etc.), all-terrain recreational vehicles (dune buggies, jet skis, snowmobiles, ATVs, etc.), medical and educational equipment/services, information technology and telecommunications equipment/services, heavy machinery (caterpillars, scaffolding, etc.), timeshares, and any service that could be financed. In general, the principles of the present invention can be applied to any product or service that can be purchased or leased with periodic payments whether the interest is compounded or simple. The method of the present invention also applies to residual purchase loans and to interest only loans (with or without balloon payments). For example, in an interest only loan, the payment required is an interest only payment and at the end of the term, the full balance becomes due or is amortized for another period. By using the method of the present invention, it is possible to decrease the resulting balance when the term is complete. The method of the present invention could also be applied to refinanced loans, cash out loans and reconfigured loans. More specifically, the method of the present invention is not limited to being performed at the time of purchase or lease, but rather, can be performed at any time during the life of a loan.

The present invention could also be provided by employers as a benefit to their employees. Specifically, employers could provide the method of the present invention to their employees or the employer could allow another party to provide such a service through the company.

Although the present invention is described herein with the use of monthly and biweekly periods, it should be readily understood by a person skilled in the art that this invention can be implemented with any first and second period that do not necessary have a fixed relationship. The monthly/biweekly embodiment with a ratio of about 2.17 is only one example. In general, any ratio of a first (longer) period to a second (shorter) period of more than two would achieve the same result at described herein.

Furthermore, although the seller, lender and third party are described as individuals, each of these three entities should be regarded as simply providing a function. Specifically, the present invention contemplates that all of these functions could be handled by a single company or person or that the functions could be divided in any suitable manner. Additionally, the present invention contemplates a situation in which the third party works directly with the borrower or directly with the seller or lender.

The embodiments described herein are intended to be illustrative of this invention. As will be recognized by those of ordinary skill in the art, various modifications and changes can be made and would remain within the scope of the invention defined in the appended claims.

What is claimed is:

1. A method for financing a product or service, said method comprising in any sequence:
determining a first loan amount;
calculating a first periodic payment and a first term based on said first loan amount;
determining a supplemental allowance;
calculating a revised loan amount by summing the first loan amount and the supplemental allowance;
determining a revised periodic payment and a revised loan term based on said revised loan amount; and
reducing said revised loan term by applying a second periodic payment schedule based on one of said first periodic payment and said revised periodic payment.

2. The method of claim 1, wherein said first periodic payment is a monthly payment and the second periodic payment is a biweekly payment.

3. The method of claim 1, wherein said product or service is a vehicle and said supplemental allowance is utilized to purchase additional products or services related to said vehicle.

4. The method of claim 3, wherein said additional products or services include at least one of an extended warranty, upgraded audio/video equipment, upgraded performance parts, upgraded appearance items, upgraded security or safety items, cash back, and application to negative equity

5. The method of claim 1, wherein said second periodic payment is collected by a third party and said third party pays said lender.

6. The method of claim 1, wherein said determining said supplemental allowance comprises:
extending said first term to obtain said revised term; and
determining a revised loan amount by increasing said first loan amount until said revised periodic payment is substantially similar to said first periodic payment, based on said revised loan term.

7. The method of claim 1, wherein a ratio of the first period to the second period is greater than about 2 such that additional money is collected per first periodic term on average.

8. The method of claim 2, further comprising:
establishing a loan for a borrower;
scheduling biweekly payments between said borrower and a third party for one half of said monthly payment;
arranging for said third party to pay a lender once per month; and
making at least one additional payment to said lender from said third party with additional money collected from the borrower.

9. The method of claim 8, wherein said ratio is 2.17.

10. The method of claim 8, wherein said biweekly payment by the borrower to the third party is an electronic payment.

11. A method for financing an vehicle, said method comprising:
explaining a biweekly supplemental allowance program to a borrower determining whether the borrower has obtained financing and if the borrower has obtained financing:
determining whether the loan terms can be renegotiated or if a revised loan can be obtained; otherwise,
securing financing for said borrower;
enrolling borrower in said biweekly supplemental allowance program;
establishing biweekly payment schedule for borrower to pay third party one-half of monthly loan payment biweekly; and
establishing a schedule such that said third party pays a lender monthly on behalf of said borrower;
wherein said third party makes an additional principal payment from the extra payment collected during the months that a third biweekly payment is received.

12. The method of claim 11, wherein said biweekly payment is one-half of said monthly payment.

13. The method of claim 11, wherein said third party collects a service fee.

14. A computer program for configuring financing of a product or service, said program including instructions for:
accepting an input of a first loan amount;
calculating a first periodic payment and a first term based on said first loan amount;
calculating a supplemental allowance;
calculating a revised loan amount by summing the first loan amount and the supplemental allowance;
determining a revised periodic payment and a revised loan term based on said revised loan amount; and
reducing said revised loan term by applying a second periodic payment schedule based on said revised loan payment.

15. The computer program of claim 14, wherein said first periodic payment is a monthly payment and the second periodic payment is a biweekly payment.

16. The computer program of claim 14, wherein said product or service is a vehicle and said supplemental allowance is utilized to purchase additional products or services related to said vehicle.

17. The computer program of claim 16, wherein said additional products or services include at least one of an extended warranty, upgraded audio/video equipment, upgraded performance parts, upgraded appearance items, upgraded security or safety items, cash back, and application to negative equity.

18. The computer program of claim 14, wherein said second periodic payment is collect by a third party and said third party pays said lender.

19. The computer program of claim 14, wherein said calculating said supplemental allowance comprises:
extending said first term to obtain said revised term; and
calculating a revised loan amount by increasing said first loan amount until said revised periodic payment is substantially similar to said first periodic payment, based on said revised loan term.

20. The computer program of claim 14, wherein a ratio of the first period to the second period is greater than 2 such that additional money is collected per first periodic term on average.

21. The computer program of claim 15, further comprising:
calculating a loan for a borrower;
scheduling biweekly payments between said borrower and a third party for one half of said monthly payment;
arranging for said third party to pay a lender once per month; and
making at least one additional payment to said lender from said third party with additional money collected from the borrower.

22. The computer program of claim 21, wherein said additional payment is made twice per year.

23. The method of claim 21, wherein said biweekly payment by the borrower to the third party is an electronic payment.

24. A method for financing a product or service, said method comprising:
calculating an initial monthly loan payment based on an initial loan term and an initial loan amount;
calculating a supplemental loan allowance;
calculating a biweekly payment schedule based on the sum of said initial loan amount and said supplemental loan allowance
wherein said biweekly payment schedule allows repayment of said sum in a term that is substantially similar to said initial loan term.

25. The method of claim 24, further comprising:
charging a borrower at least one of an initial fee for enrollment into said biweekly payment schedule and a per payment fee for collect of said payment.

26. The method of claim 25, wherein said at least one fee is collected from said payments and said supplemental loan allowance is reduced by an amount sufficient to allow payment of said at least one fee.
